(19) United States
(12) Patent Application Publication
(10) Pub. No.: US 2004/0118216 A1
(43) Pub. Date: Jun. 24, 2004

(54) Device for measuring a force; device for measuring a pressure; and pressure sensor

(76) Inventors: Karl-Franz Reinhart, Weinsberg (DE); Christian Doering, Stuttgart (DE); Oliver Stoll, Reutlingen (DE); Michael Knauss, Pliezhausen (DE)

Correspondence Address: KENYON & KENYON, ONE BROADWAY, NEW YORK, NY, 10004, US

(21) Appl. No.: 10/647,087

(22) Filed: Aug. 22, 2003

(30) Foreign Application Priority Data
Aug. 23, 2002 (DE) 102 38 720.6

(51) Int. Cl. G01L 1/00

(52) U.S. Cl. 73/766

(57) ABSTRACT

A device or a pressure sensor for measuring a force or for measuring a pressure in a predefined direction. A packaging element, as well as a carrier element, and a sensor element are substantially compensated in relation to the sensing region of the sensor element with respect to their temperature-induced expansions.

### FIELD OF THE INVENTION

The present invention is directed to a device and a pressure sensor.

### BACKGROUND INFORMATION

In conventional pressure sensors and/or force sensors, a rod is provided that presses on a sensing region, the rod being used to induce a transmission of force between a highly thermally stressed region for which the sensor element is not suited, and a region which is not so thermally stressed, where the sensor can be accommodated.

### SUMMARY

In accordance with example devices and pressure sensors of the present invention, the need for a rod is eliminated. Instead, the sensor element is situated directly in the spatial vicinity of the highly thermally stressed region, a compensation being provided for the sensing region of the sensor element with respect to the temperature-induced expansion. This makes it possible for the sensor element of the device according to the present invention to have a smaller design and, thus, for the device according to the present invention to have an altogether smaller and less expensive design. In addition, it is also possible to attain a more precise measuring result when performing the measurement, because the temperature-induced expansion is compensated with regard to the sensing region of the sensor element. The feasibility of determining the combustion-chamber pressure in normal vehicle operation opens up new possibilities in engine management. Various useful effects are expected of engine management systems based on combustion chamber pressure, such as the reduction of emissions and noise levels, particularly for the diesel engine. An on-line diagnostics of the engine is also desirable to detect and avoid engine errors. Due to the extreme conditions prevailing in the combustion chamber, conventional, mass-produced high-pressure sensors come up against their physical limits. Temperatures of over 1000° C. prevail in the combustion chamber. At the sensor tip, these temperatures can be reduced to below 350° C. due to a thermal coupling to the cylinder wall. The narrowness of the space at the cylinder head of present-day four-valve engines also greatly limits the size of the sensor. Thus, even in a two-valve engine, at a maximum, the sensor head is supposed to have a diameter of 4 mm over an overall length of 20 mm. In a four-valve engine, a length of up to 100 mm and more is common. Therefore, since many variants are needed, one should be able to freely select the overall length. In the case of a diesel engine, the pressure range to be detected is, at a maximum, 200 bar plus approximately 100 bar safety reserve for the burst pressure. In addition, transversal accelerations of up to 30 g act on the cylinder head. For the sake of reliability of operation, it is necessary that the sensor withstand up to 30,000 temperature changes of −40° C. to 300° C., without experiencing degradation or even failure. In addition, to optimally utilize the potential of such a sensor, a dynamic resolution of up to 20 kHz is required.

At temperatures of up to 250° C., the use of possible electronic transducer principles (piezoelectric, piezoresistive, and so forth) is greatly restricted. In particular, conventional electronics based on silicon can no longer be used, since they are only useful, in terms of functioning, up to 150° C. at a maximum. For that reason, it is not possible to use polysilicon strain gauges or conventional piezo-resistors that are diffused into the silicon. The size restriction and the attainable, comparatively small signals prevent the use of metal thin-film sensor elements. Moreover, in practice, a combustion-chamber pressure sensor is not feasible where a rod transmits the displacement of a membrane in or at the combustion chamber to a micromechanical pressure sensor in the cooler range, and thereby transfers the mechanical-electrical signal conversion from the hot region at the edge of the combustion chamber to the cooler region. This is not possible because, due to the required dynamics of 20 kHz, one has to basically expect a limitation of the rod length and, thus, of the overall geometry. In concrete terms, this means, for example, that it is not possible to implement the required geometry of a diameter of less than 4 mm over more than 25 mm overall length, since flexural vibrations occur already at about 5 kHz in such a rod and in the housing. Therefore, the device for measuring a force and for measuring a pressure, and the pressure sensor, respectively, in accordance with example embodiments of the present invention, advantageously provide an electronic approach for combustion-chamber pressure sensory technology, it being possible to provide the device in accordance with the present invention in the smallest of spaces. By implementing a signal conversion directly at or relatively near the combustion chamber membrane, the aim is to circumvent the geometric limitations associated with the use of a coupling element, and to thereby render possible the required multiplicity of variants.

By using SOI material (silicon on insulator), the requirement of a temperature stability for beyond 350° C. is fulfilled. This has the advantage that the sensor element is able to be placed in relatively close proximity to the zone of the pressure to be measured, so that the device is afflicted with fewer errors arising from the transfer of pressure from the combustion chamber to the sensor element. In addition, the SOI material has the advantage that the strain-gauge resistors, whose task is to measure the deflection of the sensor element, are separated from one another by a true insulation layer. On the other hand, conventional strain-gauge resistors made of silicon are fabricated using a p-n-type well. When this technique is employed, leakage currents flow between the strain-gauge resistors already at temperatures of over 150° C. On the other hand, SOI expansion elements are suited for temperatures of up to over 350° C. By using silicon carbide on insulator as substrate material, i.e., as material for the sensor element, it is even possible to thermally load the sensor element up to temperatures of approximately 500° C.

The design technique is very significant for the application of such a sensor element. On the one hand, it must satisfy the size requirements. On the other hand, it must provide adequate thermal stability for the sensor element, as well as options for its assembly and manufacture. In addition to this, there are the requirements for dynamics and for diverse variants, for example, the lengths of the sensor head of over 10 mm at a maximum of 3 to 4 mm diameter.

In addition, it is advantageous if the sensor element has a first expansion segment, if the carrier element has a second expansion segment, and if the packaging element has a fourth expansion segment, the sum of the first and second expansion segments being provided in a predefined temperature range, as substantially equal to the fourth expansion segment. In this way, in accordance with the present invention, the temperature-induced expansion is compensated for relatively to the sensing region in an especially simple manner.

In addition, it may be advantageous if the packaging element is provided as a jacket encasing tube or as a steel encasing tube or as a metal encasing tube. In this way, it is possible to manufacture the device according to the present invention or the sensor according to the present invention very cost-effectively, particularly by using a jacket encasing tube, to thermally couple the jacket encasing tube to the cylinder wall and thereby effect a lowering of the temperature to below 300° C. The advantage of using a steel encasing tube as a supply line is that it is a standard subassembly, as is used, for example, for many other sensors as well.

### BRIEF DESCRIPTION OF THE DRAWINGS

Exemplary embodiments of the present invention are illustrated in the drawings and are explained in greater detail in the following description.

FIG. 1 shows a device in accordance with the present invention in an assembly stage.

FIG. 2 shows a device according to the present invention in a side view and in a sectional view.

FIG. 3 shows a device according to the present invention in an enlarged view.

FIG. 4 shows a detailed representation of the basic design of a first example embodiment of the device according to the present invention.

FIG. 5 shows a diagrammatic sketch illustrating expansion compensation.

FIG. 6 shows a second example embodiment of the device according to the present invention.

FIG. 7 shows a third example embodiment of the device according to the present invention.

### DESCRIPTION OF EXAMPLE EMBODIMENTS

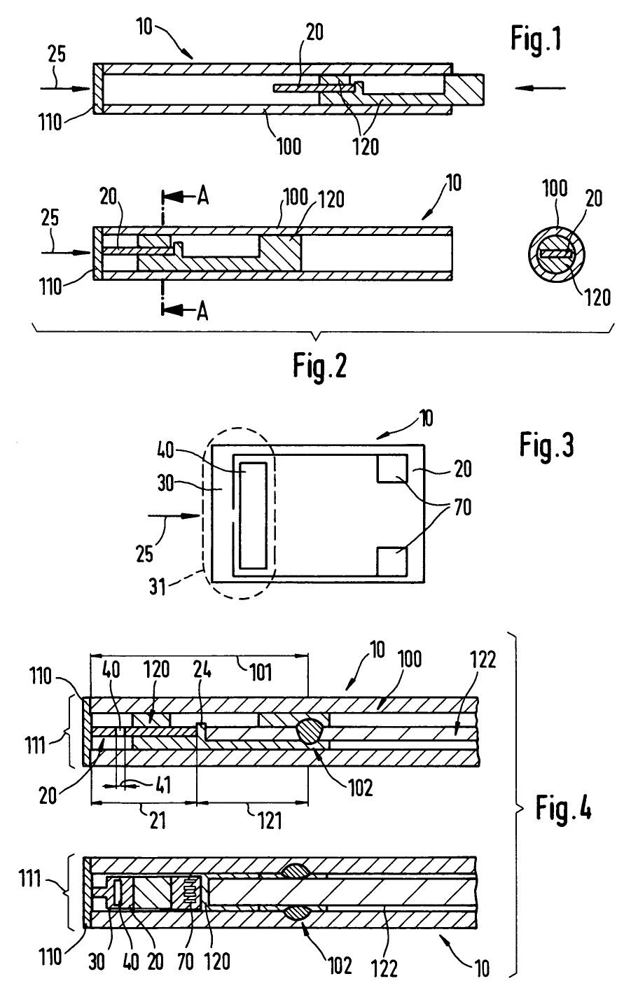

An example device according to the present invention for measuring a force and, respectively, for measuring a pressure is shown in FIG. 1 and denoted by reference numeral 10. The device includes a substrate 20, on which sensing region 31 (not shown in FIG. 1) is situated. Also shown in FIG. 1 is a carrier element 120, to which substrate 20 is fixed. Substrate 20 is provided, together with carrier element 120, in a packaging element 100 and is shifted in the direction indicated by an arrow in the right part of FIG. 1, in order to assemble device 10 in accordance with the present invention in packaging element 100. Also shown in FIG. 1 is a membrane 110, which is joined in accordance with the present invention to packaging element 110 either by using a jointing technique, such as welding, or is joined in one piece (integrally) to packaging element 100. Also provided in the left part of FIG. 1 is an arrow denoted by reference numeral 25. It indicates the direction of the force determined using device 10.

Device 10 according to the present invention is shown in FIG. 2, substrate 20, together with carrier element 120, being brought into its final position in packaging element 100. In this connection, substrate 20 pushes against membrane 110. An action of force in the direction of the arrow likewise denoted by reference numeral 25 in FIG. 2 give rise to a deformation of membrane 110 that is transmitted to substrate 20. Such a deformation may be ascertained by device 10 according to the present invention, and, accordingly, the force acting on membrane 110 may be determined. Thus, a pressure force acting on membrane 110 may be determined, from which the pressure force acting on the surface of membrane 110 and, thus, the pressure is accessible. In the right part of FIG. 2, a cross-sectional representation of device 10 according to the present invention is shown along line of intersection AA.

In an enlarged detail representation, FIG. 3 generally shows substrate 20 of device 10 according to the present invention. Substrate 20 has a sensing region 31, which, in the installed state of device 10, is oriented toward membrane 110, membrane 110 not being shown in FIG. 3, however. Illustrated, however, in FIG. 3 is direction 25 of the action of force to which sensing region 31 of substrate 20 or of device 10 is sensitive. Sensing region 31 is illustratively implemented in such a way that a micro-bar-type structure is bent by the action of force. To this end, by way of example, substrate 20 has a micro-bar 30 as a strain region 30 and a weakening zone 40, which is configured, for example, as a recess or cut-out 40 in substrate 20. Because recess 40 or, more generally stated, weakening zone 40 is provided in the direction of the action of force behind micro-bending bar 30, an action of force on strain region 30 has the effect of bending the same. This is detected by measuring elements, such as piezoresistors or strain gauges (not shown in FIG. 3), mounted in the area of strain region 30. The signals from the measuring elements are transmitted to connection surfaces 70, the transmission being carried out, in particular, via circuit traces which are applied in the form of metallizations to substrate 20. In one advantageous example embodiment, contact surfaces 70 are likewise designed as metallizations on substrate 20.

FIG. 4 is a detailed representation of device 10 according to the present invention in accordance with a first example embodiment. Substrate 20 is provided, in turn, on carrier element 120, secured in packaging element 100. Also provided is a connection element 122, which handles the external electrical connection for device 10 according to the present invention. Connected, in turn, to packaging element 100 is membrane 110, which has membrane surface 111. Thus, based on the definition of membrane surface 111, it is possible by measuring the force acting on membrane 110, to measure the pressure force and the pressure acting on membrane 110. In FIG. 4 as well, a connection surface on substrate 20 is denoted by reference numeral 70. Also discernible in FIG. 4 is strain region 30 and recess 40 in substrate 20. In the top part of FIG. 4, device 10 is shown in a side representation, substrate 20 being viewed from the side, i.e., the drawing plane is normal to the main plane of substrate 20. The bottom part of the figure shows a representation rotated by 90 degrees, so that device 10 according to the present invention can be inspected by viewing substrate 20 from one direction, from above, and the drawing plane corresponds to the main substrate plane.

By using silicon on insulator as a base, in particular, for substrate 20 of device 10, the functionality of an electronic structure may be ensured up to temperatures of above 350° C. The mechanical-electrical signal conversion may thus be carried out directly at membrane 110, i.e., at combustion-chamber membrane 110 configured as part of a pressure sensor in the combustion chamber of an internal combustion engine, i.e., at temperatures of around 300° C. The need is eliminated for a mechanical coupling of force over broad distances, by way of a rod, for example.

In accordance with the present invention, it may be particularly beneficial for sensing substrate 20 and sensing region 31 of substrate 20, respectively, to be fixed in an axial position in packaging element 100 designed as a tube. This enables one dimension of the sensor head to be 3 mm in diameter or even less. In addition, this enables the supply lead to be run over virtually any desired lengths, but in dependence upon the level of the sensor signal, and thus be able to displace the evaluation circuitry to cooler regions. This further increases the number of possible variants. By installing substrate 20 in this way so that it is vertical with respect to membrane 110, an assembly and interconnection technique is ensured where the sensor or device 10 may be contacted in a simple manner and by employing conventional technologies. It is thus possible to thermally compensate for the difference in the linear expansion of packaging element 100, on the one hand, and of substrate 20 and its carrier element 120, on the other hand, and to thereby compensate for the sensor's or device's 10 response to temperature changes by employing appropriate material combinations. One variant of this is described in the following, in the third example embodiment. The possibility proposed in accordance with the present invention for thermally compensating for the linear expansion also continues to allow or make desirable the option of mechanically compensating for the temperature response, for example, through the use of a bead (crimp) in membrane 110. The design in accordance with the present invention of device 10 which provides for inserting substrate 20, with its carrier element 120, into packaging element 100 provides for an assembly of device 10 that facilitates its manufacture and enables pretensioning of sensing region 31 of substrate 20. It is provided, in particular, in accordance with the present invention to use a ceramic plate as connection element 122, which, as a carrier, is to be provided with the supply leads not explicitly denoted by a reference numeral in FIG. 4. In this way, few component parts are needed for the supply leads, and the supply leads may be printed on the ceramic plate. In addition, it is possible in this way to mount the evaluation circuitry using hybrid technology on the supply carrier or on the connection element or also contact element 122. In accordance with the present invention, substrate 20 may be joined to carrier element 120 in various ways, such as by clamping substrate 20 to a carrier element 120 designed as a chip carrier 120. In this way, it is possible to avoid thermal stresses between carrier element 120 and chip 20 or substrate 20. Chip 20 or substrate 20 is held by pretensioning action between membrane 110 and a limit stop that is provided on chip carrier 120 and is denoted in FIG. 4 by reference numeral 24. Substrate 20 is joined in accordance with the present invention to carrier element 120, which is also referred to as chip carrier 120, for example by glazing on a sealing glass having a lowest possible thermal expansion coefficient, or it is also secured purely by using a clamping connection. In this context, substrate 20 or chip 20 is inserted from the front into chip carrier 120 and held by the same, for example, only lightly. The actual fixed mounting is implemented in this example then merely by pressing substrate 20 onto membrane 110, thereby clamping and simultaneously pretensioning the same. The advantage of such an installation is that instances of thermal incomparability, in particular with respect to the expansion coefficient of chip carrier 120, which, in accordance with the present invention, is provided in particular of steel, and substrate 20 or chip 20, which is provided of silicon or of an SOI material, do not lead to mechanical stresses at their connection. Chip carrier 120 has, for example, a thermal expansion coefficient of 10*10⁻⁶ 1/K, and substrate 20 has a thermal expansion coefficient of 2*10⁻⁶ 1/K. Once chip 20 is pushed in up to the preset limit stop 24 of chip carrier 120, it is then possible to install connection element 122, together with the supply leads. In this case, connection element 122 may be, for example, a ceramic plate, as a hybrid having imprinted supply leads. This connection element 122 conducts the signal either to the evaluation circuitry (not shown in FIG. 4) situated further back, in cooler regions, or in the case of an evaluation circuitry already integrated on substrate 20, directly to the plug connector. In the case that a ceramic plate is used as a connection element 122, substrate 20, provided, for example, as an ASIC (application specific integrated circuit), may be assembled, together with the evaluation circuitry, directly on connection element 122, which may also become wider, for example, further back in device 10. Once connection element 122, together with the supply leads, is assembled, the electrical connection of substrate 20 or of contact surfaces 70 may be implemented on substrate 20 and on the supply leads in connection element 122. This is achieved in accordance with the present invention, in particular by the wire bonding of connection surfaces 70, i.e., of contact pads 70 of substrate 20 to corresponding connection surfaces on connection element 122, which are not explicitly shown in FIG. 4, or, however, also by welding.

The ready-contacted and assembled substrate 20 may then be inserted, together with chip carrier 120 and connection element 122, from behind, into packaging element 100, up to membrane 110. This process is also illustrated in FIG. 1. Chip carrier 120 is formed in such a way that it is simultaneously used as guidance for the entire formation in packaging element 100, provided, for example, as jacket encasing tube. This may be implemented, for example, by a round design in cross section; compare the right part of FIG. 2. In this way, it is ensured that carrier element 120 may be used as guidance in packaging element 100, because the cross section of the carrier element is adapted to the inside of packaging element 100. Following the insertion operation, substrate 20 is pretensioned. In accordance with the present invention, this operation may be monitored “on-line”, in particular electronically, by measuring the output signal at the ready-contacted sensor element. Given a continuous pretensioning action, pretensioned substrate 20 is then fixed, for example by a laser weld point between chip carrier 120 and jacket encasing tube 100. Packaging element 100 provided, for example, as jacket encasing tube 100 is so thin in accordance with the present invention that such a spot welding or also a line welding is effective. The spot welding is depicted in FIG. 4 by reference numeral 102. It is carried out at a distance 101 from the inner stop surface of membrane 110, distance 101 also being designated as fourth segment 101. In this way, the expansion behavior in response to heating is defined for different temperature situations of device 10 according to the present invention. By way of fourth segment 101 and the selection of the material of packaging element 100, the thermal expansion of packaging element 100 relevant to sensing region 31 of substrate 20 is defined, because, inside packaging element 100, the expansion likewise takes place between the inner limit stop of membrane 110 and weld 102 at a distance 101 from sensor membrane 110. In simplified terms, one can initially assume a constant thermal expansion coefficient in the considered temperature range of between about −40° C. and +350° C. This means that, inside the packaging element, the linear deformation of substrate 20 is governed by the expansion coefficient of substrate 20 and occurs over a distance of the segment between the inside of membrane 110 and limit stop 24 on chip carrier 120. This relevant length of chip 20 is also referred to in the following as a first segment and is denoted by reference numeral 21 in FIG. 4. In the remaining area of fourth segment 101, the extension of chip carrier 120 is relevant. This second segment is denoted by reference numeral 121. In accordance with the present invention, it is intended that the action of force on sensing region 31 of substrate 20 depend only on the force acting on membrane 110 and that it not result from various linear expansions induced by the temperature of the system. Less thermal expansion inside packaging element 100 would, in a warming process, necessarily simulate less action of force on sensor element 20 or substrate 20. In this respect, it is provided in accordance with the present invention that the linear expansions produced by the effect of temperature, be kept substantially constant in relation to sensing region 31 of substrate 20. This is accomplished in accordance with the present invention, in particular by properly selecting the materials of substrate 20, of chip carrier 120, and of packaging element 100, and by properly selecting segments 110, 21 and 121. Given a compensated temperature situation at a specific temperature level, it is, therefore, provided in accordance with the present invention that the lengths to be compared, i.e., on the one hand, length 101 and, on the other hand, the sum of lengths 21 and 121 be equal, independently of the temperature. The means that the absolute, temperature-induced linear deformations of the considered segments are equal. These linear deformations, which are also referred to in the following as expansion segments, are derived for each of segments 21, 121, 101 from the product of the temperature difference at a given reference temperature, expansion coefficient α, which is specific to the selected material, and the length of the segment at the reference temperature. The first expansion segment is the temperature-induced expansion of first segment 21. The second expansion segment is the temperature-induced expansion of second segment 121. The fourth expansion segment is the temperature-induced expansion of fourth segment 101. For that reason, the fourth expansion segment should correspond to the sum of the first expansion segment and the second expansion segment, so that the equation

ΔT*(α₁₀₀*x₁₀₀=ΔT*α₂₀*x₂₀+ΔT*α₁₂₀*x₁₂₀

results.

On the further condition that x₁₀₀ corresponds to the sum of x₂₀ and x₁₂₀, a condition for the ratio of segments x₁₀₀ to x₁₂₀ is derived from the known expansion coefficients α for the particular materials. For the compensated temperature conditions, this ratio must be

$$\frac{{α}_{20} - {α}_{120}}{{α}_{100} - {α}_{120}}$$

over all of the relevant segments at any one time.

Here, x₁₀₀ corresponds to the relevant segment in packaging element 100, i.e., in fourth segment 101, at the reference temperature. In addition, x₂₀ corresponds to the relevant segment in substrate 20, i.e., in first segment 21, at the reference temperature. Furthermore, x₁₂₀ corresponds to the relevant segment in substrate carrier 120, i.e., in second segment 121, at the reference temperature. From the length of fourth segment 101 and, thus, its ratio to second segment 121 and, respectively, from the location of weld 102, given compensated temperature conditions, it is possible for the temperature-induced expansion of substrate 20, of packaging element 100, and of chip carrier 120, to be substantially compensated relative to sensing region 31 of substrate 20, respectively, of sensor element 20. Taking as a basis an uncompensated temperature characteristic over the entire relevant segments 101, 21, 121, it is likewise possible in accordance with the present invention to compensate for the temperature-induced expansion of elements 20, 120, 100 by selecting a segment ratio other than the one mentioned, that is decisive for compensated temperature.

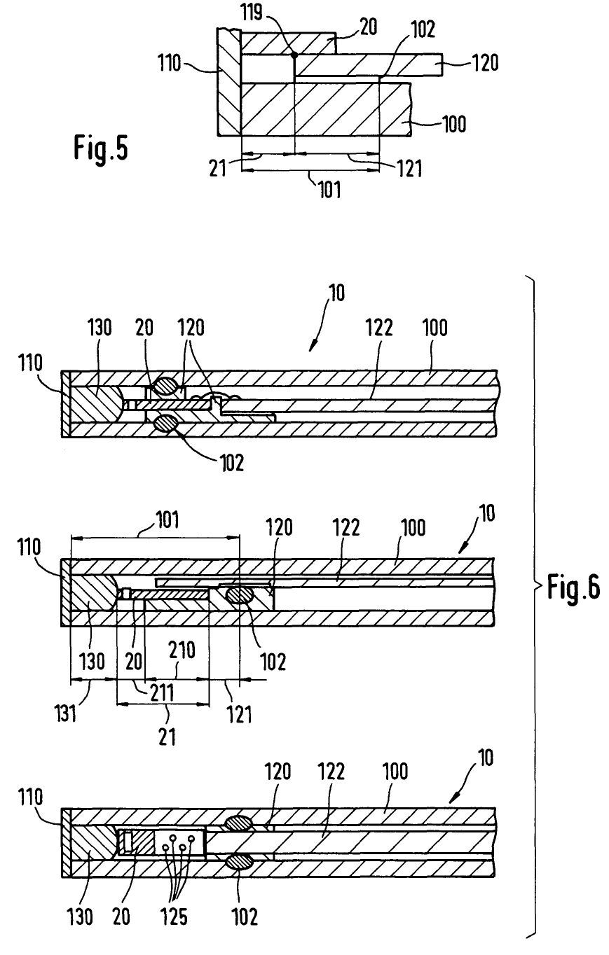

If chip carrier 120 is joined at the distance of fourth segment 101 to housing 100, given compensated temperature conditions, temperature-related differences in the length variations of the various materials do not lead to a displacement of sensing region 31 of substrate 20. Consequently, the assembly is thermally compensated. This thermal compensation is shown once again schematically in FIG. 5, with fourth segment 101 of packaging element 100 between the inner surface of membrane 110 and welding spot 102, with first segment 21 relevant for the expansion of substrate 20 and second segment 121 relevant to the expansion of chip carrier 120. Here, between substrate 20 and chip carrier 120 at the location denoted by reference numeral 119, a connection is produced, for example, by welding or clamping, so that, for first segment 21 of substrate 20, only the segment between the membrane and the connection at the location denoted by reference numeral 119 is relevant. In FIG. 4, on the other hand, due to limit stop 24 provided there, the entire length of substrate 20 is relevant.

FIG. 6 shows a second example embodiment of device 10 according to the present invention. A substrate 20 is provided, in turn, on chip carrier 120 in a packaging element 100, a connection element 122 being provided for external connections. At its one end, packaging element 100 includes membrane 110. To compensate for the temperature-induced linear expansion of packaging element 100, additionally provided, in this instance, inside packaging element 100 is a compensation element 130, which is provided between membrane 110 and substrate 20.

In the top part of FIG. 6, a design is shown, which, except for compensation element 130, corresponds to that in FIG. 4, chip 20 being mounted on chip carrier 120 and contacting contact element 122, in particular via wire bonding. For that reason, the linear deformation of compensation element 130 corresponding to the third expansion segment is additionally to be considered as a temperature-induced linear deformation inside packaging element 100. The third linear deformation is derived from the third segment provided with the reference numeral, i.e., from the relevant expansion of compensation element 130, multiplied by the temperature difference and the expansion coefficient. By considering the expansion of compensation element 130, as well, and by properly selecting the material of compensation element 130, it is possible to compensate for the particular linear deformations through a temperature change for sensing region 31 of substrate 20.

In the middle and bottom parts of FIG. 6, a design employing flip-chip contacting of substrate 20 by contact element 122 is shown. The flip-chip contacting points are provided in FIG. 6, in the bottom part of the figure, with reference numeral 125. In the bottom part of FIG. 6, a plan view of substrate 20 is shown, and, in the middle part of FIG. 6, a representation having a corresponding 90-degree rotation is selected, so that substrate 20 is seen from the side. The middle part of FIG. 6 shows the segments that are decisive for the temperature-induced linear deformation: Fourth segment 101 corresponds again to the relevant segment length of packaging element 100, third segment 131 corresponds to the relevant expansion segment of compensation element 130, and first segment 21 is divided into a first section 211 and a second section 210. Second segment 121, where the linear expansion of chip carrier 120 is relevant, is likewise shown in the middle part of FIG. 6. Overall, therefore, the temperature-induced linear deformation of segment 101 corresponding to the fourth expansion segment is to be compared to the temperature-induced linear deformation of the sum of segments 131, 21 and 121, i.e., with the sum from the first, the second, and the third expansion segment. In accordance with the present invention, the division of first segment 21 into first and second sections 210, 211 is attributable to the material in the region of first section 211 having a different temperature expansion coefficient than the substrate material in the region of section 210. This may be attributable, for example, to the fact that, in the region of second section 210, besides the temperature expansion coefficient of the substrate material, due to its connection in this region to substrate carrier 120, the temperature expansion coefficient of substrate carrier 120 also influences the thermal expansion. For this case, sections 210, 211 must be considered separately, of course, as indicated in FIG. 6.

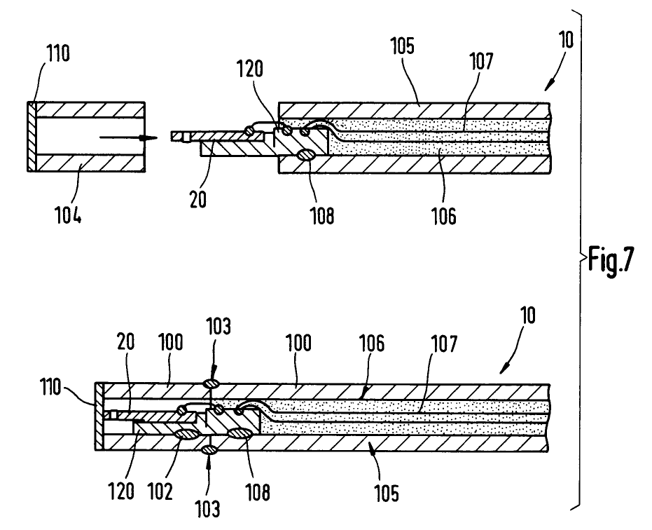

A third example embodiment of device 10 according to the present invention is shown in FIG. 7. Here, packaging element 100 is provided in the form of a first part 104 and a second part 105. Sensor membrane 110 is provided on the first part 104 of packaging element 100. First part 104 is also referred to in the following as packaging head 104. Second part 105 of packaging element 100 is provided in the third example embodiment of the device according to the present invention in the form of a metal encasing tube or steel encasing tube, which, on the inside, has a ceramic material, in particular of powder, which is denoted by reference numeral 106 and which, additionally on the inside, has metal wires denoted by reference numeral 107. Also shown in the third exemplary embodiment of the device according to the present invention is substrate 20, chip carrier 120, and weld point 102, i.e., welding joint 102, between first part 104 of packaging element 100 and chip carrier 120. Substrate 20 is joined using wire bonding, for example, or also direct welding, to chip carrier 120, and this is connected, in turn, using a suitable contacting technique, to metal wires 107 in the metal encasing tube. However, substrate 20 may also be directly contacted by metal wires 107 in the manner mentioned. For the assembly operation, substrate 20, together with its chip carrier 120, is installed in second part 105 of packaging element 100 and connected, for example, by a weld point 108. First part 104 of packaging element 100 is subsequently placed on second part 105 and, joined under prestressing to second part 105 of packaging element 100, forming a weld point 103 or a welding joint 103. Packaging element 100 is hereby provided as a packaging head 104 that is connected to a steel jacket tube 105. Subsequently, for linear-expansion compensation in accordance with the present invention, weld point 102 is also placed between packaging element 100 and chip carrier 120.

When device 10 according to the present invention is used in one of the exemplary embodiments as a pressure sensor and, in particular, as a combustion-chamber pressure sensor of an internal combustion engine, it is helpful to provide for heat dissipation of the sensor head, i.e., of the front part of device 10. This may be accomplished, for example, via a thermal contact with the cylinder-head material in the direct vicinity of membrane 110. For operation in a temperature range that is suited for a perfect functioning of the sensor, such a heat dissipation may be very important. To this end, a sealing surface is created at the sensor head. This is not shown in the figures, however.

Compensation element 130 is provided in accordance with the present invention, in particular as a rod of a material having a higher expansion coefficient. The rod length and the fixing point must, of course, be suitably selected in accordance with the present invention.

What is claimed is:

1. A device for measuring a force in a predefined direction, comprising:
a sensor element having a sensing region;
a carrier element, the sensor element being connected to the carrier element;
a packaging element, the sensor element and the carrier element being at least partially surrounded by the packaging element, the carrier element and the packaging element being joined to one another in such a way that, in the predefined direction, a temperature-induced expansion of the sensor element, the carrier element and the packaging element is substantially compensated in relation to the sensing region of the sensor element.

2. The device as recited in claim 1, wherein the sensor element has a first expansion segment, the carrier element has a second expansion segment, and the packaging element has a fourth expansion segment, and wherein in a predefined temperature range, a sum of the first and second expansion segments being provided, independently of temperature, as substantially equal to the fourth expansion segment.

3. The device as recited in claim 1, further comprising:
a compensation element, the carrier element and the packaging element being joined to one another in such a way that, in the predefined direction, a temperature-induced expansion of the sensor element, the carrier element, the packaging element, and the compensation element is substantially compensated for the sensing region of the sensor element.

4. The device as recited in claim 3, wherein the sensor element has a first expansion segment, the carrier element has a second expansion segment, the compensation element has a third expansion segment, and the packaging element has a fourth expansion segment, wherein in a predefined temperature range, a sum of the first, second, and third expansion segments are provided, independently of temperature, as substantially equal to the fourth expansion segment.

5. The device as recited in claim 1, wherein the packaging element includes one of a jacket encasing tube or a steel encasing tube.

6. The device as recited in claim 1, further comprising:
a membrane, wherein in one predefined temperature range, a force of the membrane acting on the sensing region is the same, independent of temperature.

7. The device as recited in claim 6, wherein one of:
i) the membrane is joined in one piece to the packaging element, or ii) the membrane is joined to the packaging element using a jointing technique.

8. The device as recited in claim 1, wherein the carrier element and the packaging element are joined to one another by welding.

9. The device as recited in claim 8, wherein the welding is a laser welding.

10. The device as recited in claim 1, wherein the sensor element includes a substrate material, the substrate material being one of silicon on insulator or silicon carbide on insulator.

11. The device as recited in claim 1, further comprising:
a connection element, the connection element being directly or indirectly joined to the sensor element using at least one of wire bonding and flip-chip contacting.

12. The device as recited in claim 1, wherein the packaging element is a steel encasing tube provided with metal wires, the metal wires being joined by welding or bonding directly to the sensor element or indirectly via the carrier element to the sensor element.

13. The device as recited in claim 1, wherein the carrier element has a guidance function in the packaging element due to a cross-section design of the carrier element.

14. The device as recited in claim 1, wherein the packaging element includes a packaging head that is connected to a steel jacket tube.

15. A device for measuring a pressure, comprising:
a sensor element having a sensing region;
a carrier element, the sensor element being connected to the carrier element;
a packaging element, the sensor element and the carrier element being at least partially surrounded by the packaging element, the carrier element and the packaging element being joined to one another in such a way that, in the predefined direction, a temperature-induced expansion of the sensor element, the carrier element and the packaging element is substantially compensated in relation to the sensing region of the sensor element;
wherein a measurement of a pressure force acting on a measurement surface is used in measuring the pressure.

16. A pressure sensor, comprising:
a sensor element having a sensing region;
a carrier element, the sensor element being connected to the carrier element;
a packaging element, the sensor element and the carrier element being at least partially surrounded by the packaging element, the carrier element and the packaging element being joined to one another in such a way that, in the predefined direction, a temperature-induced expansion of the sensor element, the carrier element and the packaging element is substantially compensated in relation to the sensing region of the sensor element;
wherein a measurement of a pressure force acting on a measurement surface is used in measuring the pressure.
